(19) United States
(12) Patent Application Publication
(10) Pub. No.: US 2022/0114686 A1
(43) Pub. Date: Apr. 14, 2022

(54) ACCOUNT INHERITANCE

(71) Applicant: Capital One Services, LLC, McLean, VA (US)

(72) Inventors: Chelsea YIP, Brooklyn, NY (US); Ricardo VIVANCO, Washington, DC (US); Kenneth AU, Downingtown, PA (US); Immad MOHAMED, Brooklyn, NY (US)

(73) Assignee: Capital One Services, LLC, McLean, VA (US)

(21) Appl. No.: 17/070,629

(22) Filed: Oct. 14, 2020

(51) Int. Cl. G06Q 50/18; G06Q 30/00; G06Q 10/10; G06Q 50/26; G06Q 40/02; H04L 29/06; G06F 9/54; G06F 16/955; G06F 40/205

(52) U.S. Cl. CPC G06Q 50/186; G06Q 30/0185; G06Q 10/10; G06Q 50/265; G06F 40/205; G06Q 30/016; H04L 63/0853; G06F 9/54; G06F 16/955; G06Q 40/02

(57) ABSTRACT

Disclosed herein are system, method, and apparatus for account inheritance. The method performed at a gateway server includes generating a user access token based on user information received at the gateway server, and receiving information identifying a deceased. The method includes determining one or more account identifiers corresponding to one or more accounts associated with the deceased. The method includes determining a list of beneficiaries corresponding to the one or more accounts associated with the deceased, and generating a record including the user information, the information identifying the deceased, the one or more account identifiers, and the list of beneficiaries for storing in a databased using user access token, thereby generating a form accessible based on the user access token to display content corresponding to the record stored in the database.

### BACKGROUND

It is a difficult situation for any human-being when his/her loved one passes away. A person that passes usually has a will that leaves their estate to a number of beneficieries. However, the sorrow and grief associated with a loss of loved one are multiplied each time a beneficiary appointed by the deceased has to contact a customer service representative of various banks, investment organizations, etc., to inherit various accounts. For example, a beneficiary of multiple accounts being held at a bank needs to provide information about the deceased to a customer service representative. Unfortunately, the beneficiary needs to contact a different customer service representative for each account at the bank to transfer the account into his name. Accordingly, transferring more than one account to the beneficiary is a painful and lengthy process.

### BRIEF DESCRIPTION OF THE DRAWINGS/FIGURES

The accompanying drawings are incorporated herein and form a part of the specification.

FIG. 1 illustrates a block diagram of an example network environment, according to some embodiments.

FIG. 2 is a flowchart illustrating a method for account inheritance, according to some embodiments.

FIG. 3 illustrates an example computing system, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Various embodiments of this disclosure will be discussed with respect to the corresponding figures.

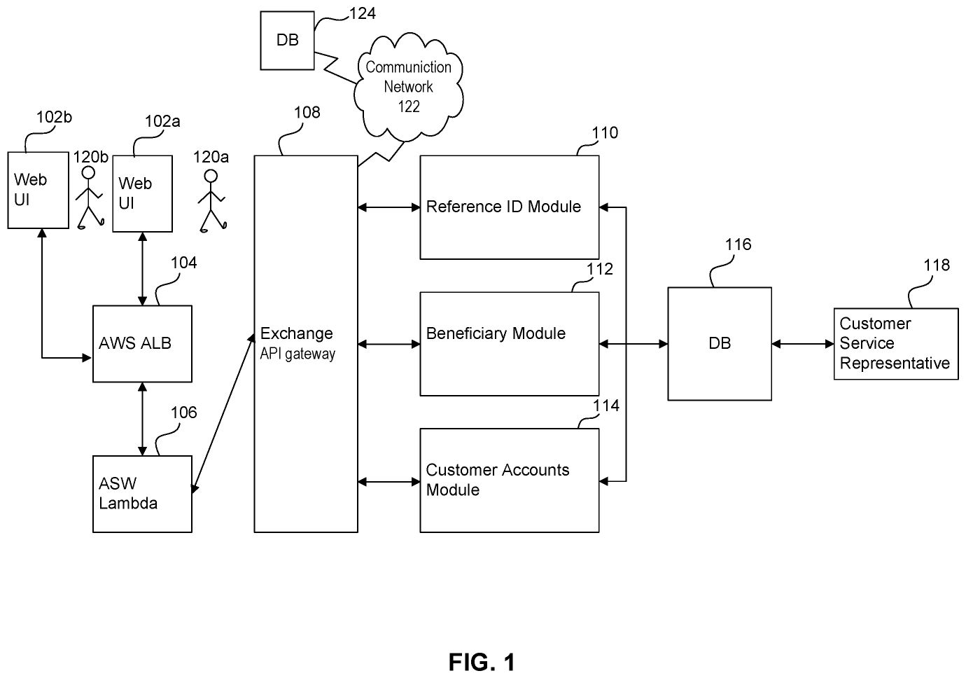

FIG. 1 illustrates a block diagram of an example network environment in which various embodiments described in this disclosure may be practiced. The example network environment includes a web user interface (UI) 102a and another web UI 102b providing service to a user 120a and a user 120b, respectively, a web service application load balancer (ALB) 104, Lambda or other event-driven, serverless function 106, and an application programming interface (API) gateway 108. The user 120a or the user 120b may be referenced in this disclosure as a user 120. In addition, the example network environment includes various services/modules 110, 112, and 114, a database 116, and a customer service representative 118.

In the example network environment shown in FIG. 1, the web UIs 102a and 102b provides to users 120s, such as the user 120a and the user 120b, an interface to create an account with a financial institution, where the financial institution manages one or more accounts held by a deceased. The user 120 may be a beneficiary or an executor of an estate of a deceased. The web UI 102 also enables the user 120 to provide information that identifies the deceased. Such identifying information may include the first and last name of the deceased, date of birth of the deceased, a social security number, or other unique identification number associated with the deceased. The user 120 may also provide information identifying accounts held by the deceased person. Generally, the beneficiary or the executor of the estate needs to contact a customer service representative 118 via phone or paper mail for each account, for example, a checking account, a savings account, a fixed deposit account, a money market account, an auto loan account, a credit card account, and/or any other type of investment account, held by the deceased. Accordingly, inheriting one or more accounts held by the deceased at the financial institution is a lengthy and painful process, as described above.

The user 120, if he does not have an account with the financial institution, may obtain authentication credentials or open a provisional account to communicate with the financial institution using the web UI 102 for the purpose of inheriting an account and/or managing the estate of the deceased. The user 120 may provide their identifying information, such as first and last name, date of birth, social security number, or other unique identifying information of the user 120.

The user 120 may also upload documents supporting their claim for inheriting or managing the accounts held by the deceased. The documents may be uploaded securely and digitally using the web UI 102. By way of a non-limiting example, the user 120 may upload documents that provide proof of the death of the member holding one or more accounts at the financial institution and/or proof of identification. The Exchange API gateway 108 may verify the authenticity of the information in the received documents. The Exchange API gateway 108 may parse the uploaded documents for extracting information regarding the deceased and verify the authenticity of the extracted information using an application programming interface for accessing a database 124 that includes death records. The Exchange API gateway 108 may also verify proof of identification by the user 120a or 120b using an application programming interface to other application server or database. Other service providers may operate such a database storing death records, driver's license information, social security number, etc. By way of a non-limiting example, the database 124 may be a cloud-based database and the Exchange API gateway 108 may access the database 124 via a communication network 122. The communication network may be wireline or wireless network based on 3G, 4G, 5G, 6G, LAN, WLAN, MAN, WAN, Internet, etc. The Exchange API gateway 108 may also store the uploaded documents in the database 116, and the customer service representative 118 may verify the details provided in the uploaded documents and saved in the database against a user access token, which is described below. By way of a non-limiting example, the database 116 may be a cloud-based database and be accessed via the communication network 122.

The web service ALB 104 is a load balancer to manage web traffic from a plurality of users 120s, such as a user 120a and a user 120b, via a web UI 102a and a web UI 102b, respectively. The web service ALB 104 may distribute web traffic from the plurality of users 120s via a plurality of web UIs 102s to various instances of the ASW Lambda 106 and the Exchange API gateway 108. In the example network environment shown in FIG. 1, though only one instance of the web service ALB 104, the Exchange API gateway 108, and ASW Lambda 106 are shown, there may be more than one instance for the web service ALB 104, the Exchange API gateway 108, and/or ASW Lambda 106. In some embodiments, by way of a non-limiting example, the web traffic from the web UI 102 may be directly routed to the Exchange API gateway 108 when the web traffic volume is comparatively low, and no more than one instance of the web service ALB 104, the Exchange API gateway 108 may be required. The ASW Lambda 106 enables code to be executed for the backend service such that the web traffic can be directed to an appropriate Exchange API gateway 108 based on the type of request being made by various beneficiaries or executors via the web UI 102.

The Exchange API gateway 108 may receive a request from the user 120 via the web UI 102. The request from the user 120 may include information that identifies the user 120, which may be used to generate a user access token for the user 120. The Exchange API gateway 108 may generate the user access token using an algorithm based on the information provided by the user 120. The generated user access token may be returned to the user 120 in response to the received request via the web UI 102. The generated user access token and the information identifying the user 120 may be stored in a database, for example, a database 116, via a module or service providing an interface between the Exchange API gateway 108 and the database 116. The user access token is a unique identifier assigned to the user 120 that can then be used in future communications with the institution regarding the multiple accounts.

The Exchange API gateway 108 may also receive information identifying the deceased. Using the information identifying the deceased, the Exchange API gateway 108 may obtain one or more accounts held at the financial institute by the deceased. The Exchange API gateway 108 may use an application programming interface (API) or any other suitable interface to communicate with a customer accounts module 114. By way of a non-limiting example, the customer accounts module 114 may be implemented as a service. The customer accounts module 114 may be configured to store and retrieve one or more accounts held at the financial institution in the database 116 based on any combination of first name, last name, date of birth, and social security number or any other unique identification number, etc. Accordingly, the Exchange API gateway 108 may pass the information identifying the deceased to the customer accounts module 114. The customer accounts module 114 may query the database 116 using the information identifying the deceased to get details about one or more accounts held by the deceased at the financial institution. The one or more accounts held by the deceased as retrieved from the database 116 is then returned to the Exchange API gateway 108 as an API response or using any other suitable interface between the Exchange API gateway 108, and the customer accounts module 114.

The Exchange API gateway 108 may then retrieve beneficiary information for each account of the one or more accounts held by the deceased as returned by the customer accounts module 114. The Exchange API gateway may send the one or more accounts to a beneficiary module 112 using an API or any other suitable interface. By way of a non-limiting example, the beneficiary module 112 may be implemented as a service. The beneficiary module 112 may be configured to store and retrieve beneficiary information corresponding to each account held at the financial institution in the database 116. Accordingly, the beneficiary module may query the database 116 to retrieve beneficiary information corresponding to the one or more accounts of the deceased. Each account of the one or more accounts held by the deceased may be stored in the database 116 based on a unique account identifier.

A database record stored in the database corresponding to the unique account identifier includes data, such as information about the account holder, beneficiary information, transaction history, current balance, etc. The beneficiary information stored in the database record may include the name of one or more persons or organizations that the deceased nominated earlier and their associated role, for example, a beneficiary or an executor of the estate. In the case when there is more than one beneficiary nominated by the deceased, the database record may also indicate a percentage share for each beneficiary. For example, if the deceased has appointed a person A and an organization B as the beneficiaries, the deceased may designate the person A and the organization B as the beneficiary of 70% and 30%, respectively.

The beneficiary module 112 may send to the Exchange API gateway 108 beneficiary information corresponding to each account of the one or more accounts in the request from the Exchange API gateway 108. Upon receipt of the beneficiary information corresponding to each account of the one or more accounts held by the deceased, the Exchange API gateway 108 may communicate to a reference ID module 110 with the information provided by the beneficiary or the executor of the estate for their identification along with the beneficiary information received from the beneficiary module 112. The reference ID module 110 may be configured to verify whether the user 120a or 120b is nominated as a beneficiary and/or executor of one or more accounts held at the financial institution. The reference ID module 110 may perform a check to verify whether the user 120 has been nominated as a beneficiary or an executor of any of the accounts held by the deceased. Upon verification, the reference ID module 110 may send information related to accounts held by the deceased in which the user 120 is nominated as the beneficiary and executor. The reference ID module 110 may also create a database record in the database 116 to store information including one or more accounts held by the deceased in which the user 120 is nominated as the beneficiary and executor using the user access token generated by the Exchange API gateway for the user 120.

If the user 120 is determined to be a beneficiary or an executor of the one or more accounts held by the deceased, the Exchange API gateway may generate a response indicating the user 120 is a beneficiary or an executor of the estate of the deceased along with information about the one or more accounts in which the user 120 has been nominated as a beneficiary or an executor. The user 120 may be given user access and management rights to the one or more accounts held at the financial institution in the estate of the deceased. The user 120 may also be notified by the Exchange API gateway 108 that a customer service representative 118 will contact the user 120 or to contact the customer service representative 118. When the user 120 contacts the customer service representative 118, the customer service representative 118 may access the database 116 to retrieve information stored in the database using the user access token generated corresponding to the user 120.

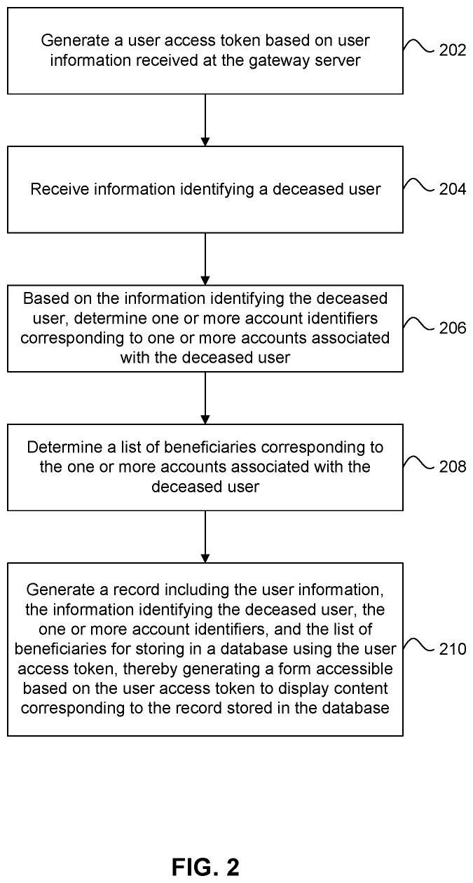

FIG. 2 is a flowchart illustrating a method for account inheritance, according to some embodiments. At step 202, a user access token may be generated based on user information received at the Exchange API gateway 108. As described above, the user access token may be generated based on the information received from the user 120 using an algorithm based on the information provided by the user 120. The information received from the user 120 may include information identifying the user 120, such as first and last name, date of birth, social security number, or other unique identifying information of the user 120. The Exchange API gateway 108 may return the generated user access token to the user 120 in response to the received request via the web UI 102. The generated user access token and the information identifying the user 120 may be stored in the database 116, via a module or service providing an interface between the Exchange API gateway 108 and the database 116.

At step 204, information identifying a deceased may be received at the Exchange API gateway. As described above, the user 120 may also provide information identifying accounts held by the deceased person. Such identifying information may include the first and last name of the deceased, date of birth of the deceased, a social security number, or other unique identification number associated with the deceased.

At step 206, based on the information identifying the deceased, one or more account identifiers corresponding to one or more accounts associated with the deceased may be determined or received by the Exchange API gateway 108. As described above, using the information identifying the deceased, the Exchange API gateway 108 may obtain one or more accounts held at the financial institution by the deceased. The Exchange API gateway 108 may use an application programming interface (API) or any other suitable interface to communicate with a customer accounts module 114. The Exchange API gateway 108 may pass the information identifying the deceased to the customer accounts module 114. The customer accounts module 114 may query the database using the information identifying the deceased to get details about one or more accounts held by the deceased at the financial institution. The one or more accounts held by the deceased as retrieved from the database 116 is then returned to the Exchange API gateway 108 as an API response or using any other suitable interface between the Exchange API gateway 108, and the customer accounts module 114.

At step 208, a list of beneficiaries corresponding to the one or more accounts associated with the deceased may be determined or retrieved by the Exchange API gateway 108. As described above, the Exchange API gateway 108 may retrieve beneficiary information for each account of the one or more accounts held by the deceased as returned by the customer accounts module 114. Using an API or any other suitable interface, the Exchange API gateway 108 may send the one or more accounts to a beneficiary module 112. The beneficiary module may query the database 116 to retrieve beneficiary information corresponding to the one or more accounts of the deceased. Each account of the one or more accounts held by the deceased may be stored in the database 116 based on a unique account identifier.

At step 210, a database record including information of the user 120, the information about the deceased, the one or more account identifiers, and the list of beneficiaries corresponding to the generated user access token for storing in the database 116 may be generated. The customer service representative 118 may access the database 116 based on the generated user access token. Appropriate forms may be generated for display to the customer service representative 118 when the customer service representative 118 receive further communication from the user 120, or the customer service representative 118 wants to initiate communication with the user 120 regarding account inheritance. In other words, the user 120 can now place a phone call to a single customer service representative 1118, and that customer service representative 118 will have access to all the accounts of the deceased thus allowing that single customer service representative to assist user 120 with all inquiries regarding their inheritance concerning these accounts.

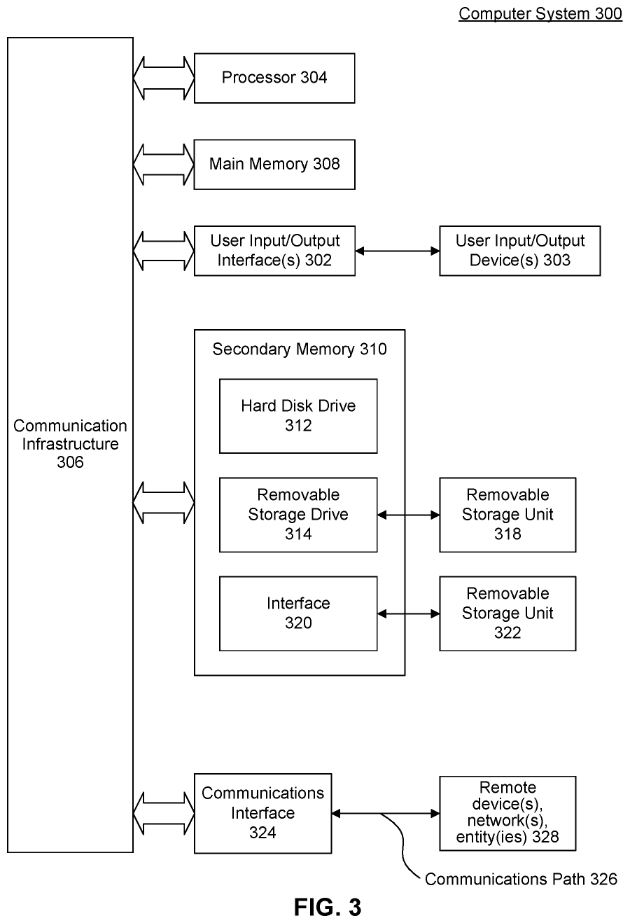

FIG. 3 illustrates an example computing system in accordance with some embodiments. Various embodiments may be implemented, for example, using one or more well-known computing systems, such as a computing system 300, as shown in FIG. 3. One or more computing systems 300 may be used, for example, to implement any of the embodiments discussed herein, as well as combinations and sub-combinations thereof. The computing systems 300, which may be a server or a mobile device may be used for the implementation of one or more embodiments described above.

The computing system 300 may include one or more processors (also called central processing units, or CPUs), such as a processor 304. The processor 304 may be connected to a communication infrastructure or bus 306.

The computing system 300 may also include user input/output device(s) 303, such as monitors, keyboards, pointing devices, etc., which may communicate with communication infrastructure 306 through user input/output interface(s) 302.

One or more processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computing system 300 may also include a main or primary memory 308, such as random access memory (RAM). Main memory 308 may include one or more levels of cache. Main memory 308 may have stored therein control logic (i.e., computer software) and/or data.

The computing system 300 may also include one or more secondary storage devices or memory 310. The secondary memory 310 may include, for example, a hard disk drive 312 and/or a removable storage device or drive 314. The removable storage drive 314 may be a floppy disk drive, a magnetic tape drive, a compact disk drive, an optical storage device, tape backup device, and/or any other storage device or storage drive.

The removable storage drive 314 may interact with a removable storage unit 318. The removable storage unit 318 may include a computer-usable or readable storage device having stored thereon computer software (control logic) and/or data. The removable storage unit 318 may be a floppy disk, magnetic tape, compact disk, DVD, optical storage disk, and/any other computer data storage device. The removable storage drive 314 may read from and/or write to the removable storage unit 318.

The secondary memory 310 may include other means, devices, components, instrumentalities, or other approaches for allowing computer programs and/or other instructions and/or data to be accessed by the computing system 300. Such means, devices, components, instrumentalities, or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computing system 300 may further include a communication or network interface 324. The communication interface 324 may enable the computing system 300 to communicate and interact with any combination of external devices, external networks, external entities, etc. (individually and collectively referenced by reference number 328). For example, the communication interface 324 may allow the computing system 300 to communicate with the external or remote devices 328 over communications path 326, which may be wired and/or wireless (or a combination thereof), and which may include any combination of LANs, WANs, the Internet, etc. Control logic and/or data may be transmitted to and from the computing system 300 via the communication path 326.

The computing system 300 may also be any of a personal digital assistant (PDA), desktop workstation, laptop or notebook computer, netbook, tablet, smartphone, smartwatch or another wearable, appliance, part of the Internet-of-Things, and/or embedded system, to name a few non-limiting examples, or any combination thereof.

The computing system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computing system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, the computing system 300, the main memory 308, the secondary memory 310, and the removable storage units 318 and 322, as well as tangible articles of manufacture embodying any combination of the foregoing. Such control logic, when executed by one or more data processing devices (such as the computing system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

What is claimed is:

1. A method, comprising:
generating, at a gateway server, a user access token based on user information received at the gateway server;
receiving, at the gateway server, information identifying a deceased;
based on the information identifying the deceased, determining, at the gateway server, one or more account identifiers corresponding to one or more accounts associated with the deceased;
determining, at the gateway server, a list of beneficiaries corresponding to the one or more accounts associated with the deceased; and
generating, at the gateway server, a record including the user information, the information identifying the deceased, the one or more account identifiers, and the list of beneficiaries for storing in a database using the user access token,
thereby generating a form accessible based on the user access token to display content corresponding to the record stored in the database.

2. The method of claim 1, wherein the user access token is generated based on the user information comprising a first name, a last name, a date of birth, and/or a unique identifier assigned to a user requesting access to the one or more accounts associated with the deceased.

3. The method of claim 1, further comprising:
receiving, at the gateway server, a documentation for verifying a death of the deceased; and
verifying, at the gateway server, authenticity of information in the received documentation.

4. The method of claim 3, wherein the verifying the authenticity of the information further comprises:
parsing the documentation for extracting information regarding the deceased; and
verifying the authenticity of the extracted information using an application-programming interface (API) for accessing a second database including data regarding the death of the deceased.

5. The method of claim 1, wherein the user information received at the gateway server is associated with a beneficiary or an executor of an estate of the deceased.

6. The method of claim 1, further comprising:
identifying, at the gateway server, a status of a user as a beneficiary, a non-beneficiary, or an executor of an estate of the deceased based on the received user information and the list of beneficiaries corresponding to the one or more accounts associated with the deceased,
wherein the estate of the deceased comprises the one or more accounts associated with the deceased.

7. The method of claim 6, further comprising:
in response to identifying the status of the user as the beneficiary or the executor, granting, at the gateway server, the user access and management rights to the one or more accounts in the estate of the deceased.

8. A server, comprising:
a memory for storing instructions; and
one or more processors, communicatively coupled to the memory, configured to execute the instructions, the instructions causing the one or more processors to:
generating a user access token based on user information received at the gateway server;
receiving information identifying a deceased;
based on the information identifying the deceased, determining one or more account identifiers corresponding to one or more accounts associated with the deceased;
determining a list of beneficiaries corresponding to the one or more accounts associated with the deceased; and
generating a record including the user information, the information identifying the deceased, the one or more account identifiers, and the list of beneficiaries for storing in a database using the user access token,
thereby generating a form accessible based on the user access token to display content corresponding to the record stored in the database.

9. The server of claim 8, wherein the user access token is generated based on the user information comprising a first name, a last name, a date of birth, and/or a unique identifier assigned to a user requesting access to the one or more accounts associated with the deceased.

10. The server of claim 8, wherein the one or more processors are further configured to:
receiving a documentation for verifying a death of the deceased; and
verifying authenticity of information in the received documentation.

11. The server of claim 10, to verify the authenticity of the information, the one or more processors are further configured to:
parsing the documentation for extracting information regarding the deceased; and
verifying the authenticity of the extracted information using an application-programming interface (API) for accessing a second database including data regarding the death of the deceased.

12. The server of claim 8, wherein the user information received at the gateway server is associated with a beneficiary or an executor of an estate of the deceased.

13. The server of claim 8, wherein the one or more processors are further configured to:
identifying a status of a user as a beneficiary, a non-beneficiary, or an executor of an estate of the deceased based on the received user information and the list of beneficiaries corresponding to the one or more accounts associated with the deceased,
wherein the estate of the deceased comprises the one or more accounts associated with the deceased.

14. The system of claim 13, wherein the one or more processors are further configured to:
in response to identifying the status of the user as the beneficiary or the executor, granting the user access and management rights to the one or more accounts in the estate of the deceased.

15. A non-transitory, tangible computer-readable device having instructions stored thereon that, when executed by at least one computing device, causes the at least one computing device to perform operations comprising:
generating a user access token based on user information received at the gateway server;
receiving information identifying a deceased;
based on the information identifying the deceased, determining one or more account identifiers corresponding to one or more accounts associated with the deceased;
determining a list of beneficiaries corresponding to the one or more accounts associated with the deceased; and
generating a record including the user information, the information identifying the deceased, the one or more account identifiers, and the list of beneficiaries for storing in a database using the user access token,
thereby generating a form accessible based on the user access token to display content corresponding to the record stored in the database.

16. The non-transitory, tangible computer-readable device of claim 15, wherein the user access token is generated based on the user information comprising a first name, a last name, a date of birth, and/or a unique identifier assigned to a user requesting access to the one or more accounts associated with the deceased.

17. The non-transitory, tangible computer-readable device of claim 15, wherein the instructions causes the at least one computing device to perform the operations further comprising:
receiving a documentation for verifying a death of the deceased; and
verifying authenticity of information in the received documentation.

18. The non-transitory, tangible computer-readable device of claim 17, wherein the instructions causes the at least one computing device to perform verifying the authenticity of the information by the operations further comprising:
parsing the documentation for extracting information regarding the deceased; and
verifying the authenticity of the extracted information using an application-programming interface (API) for accessing a second database including data regarding the death of the deceased.

19. The non-transitory, tangible computer-readable device of claim 15, wherein the instructions causes the at least one computing device to perform the operations further comprising:
identifying a status of a user as a beneficiary, a non-beneficiary, or an executor of an estate of the deceased based on the received user information and the list of beneficiaries corresponding to the one or more accounts associated with the deceased,
wherein the estate of the deceased comprises the one or more accounts associated with the deceased.

20. The non-transitory, tangible computer-readable device of claim 19, wherein the instructions causes the at least one computing device to perform the operations further comprising:
in response to identifying the status of the user as the beneficiary or the executor, granting the user access and management rights to the one or more accounts in the estate of the deceased.
